(19) United States
(12) Patent Application Publication
(10) Pub. No.: US 2009/0238561 A1
(43) Pub. Date: Sep. 24, 2009

(54) Method and apparatus for measuring quality of traffic performance in a passive optical network (PON)

(75) Inventors: Fung-Chang Huang, Herndon, VA (US); David H. Liu, Herndon, VA (US); Marc R. Bernard, Miramar, FL (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Vienna, Inc.

(21) Appl. No.: 12/077,477

(22) Filed: Mar. 19, 2008

(51) Int. Cl. H04B 10/08

(52) U.S. Cl. 398/25

(57) ABSTRACT

Systems and methods for measuring and reporting the performance of communications traffic in a Passive Optical Network (PON) are disclosed. According to the disclosed embodiments, the PON network may include an Optical Line Terminal (OLT) and multiple Optical Network Terminals (ONTs) downstream of the OLT. By aggregating multicast communications traffic received by the ONTs at a point downstream of the ONTs, selectively accessing the aggregated communications traffic, collecting information representative of performance of each selected communications traffic, and reporting the collected information upstream to a network management node, communications traffic in the PON network may be tested in both downstream and upstream directions. Advantages provided by the disclosed embodiments include simplification of the testing process by consolidating all performance reports in one place, enabling more flexible testing, and creating value from the collected information, such as by using the collected information in conjunction with simulation tools during customer deployment.

### BACKGROUND OF THE INVENTION

Internet Protocol Television (IPTV) delivers video content to viewers using a broadband connection over Internet Protocol (IP). Unlike traditional satellite or cable television, in which all channels are pushed constantly to the consumer's premises, IPTV delivers only the content that is selected by the consumer. For example, the consumer can request a particular program or channel from a service provider though a graphical interface, and the service provider can then deliver the requested content to the consumer. Content can be distributed on demand, and content providers can tailor the requested content and advertising based on customer preference.

In an IPTV network, broadcast television channels are delivered via Internet Protocol (IP) multicasting. Each broadcast television channel is an IP multicast group. The viewer changes the channel by leaving one group and joining a different group. Internet Group Management Protocol (IGMP) is a control mechanism used to control the delivery of multicast traffic to recipients of the traffic. IGMP messages may be used to make upstream equipment stop sending a channel (“leave request”) or begin sending another channel (“join request”). An IGMP host, such as a set-top box (STB), usually sends the IGMP messages to join or leave a multicast group.

One method of delivering IPTV content involves the use of a Passive Optical Network (PON), which delivers content over optical fiber networks all, or most of the way, to the consumer. A PON network is configured in a point-to-multipoint fashion and can transport high volumes of upstream and downstream bandwidth. A typical PON network includes an Optical Line Terminal (OLT) at a content provider's central office and a number of Optical Network Terminals (ONTs) at or near the viewers' locations.

### SUMMARY OF THE INVENTION

One embodiment of the present invention for measuring and reporting performance of communications traffic in a network is a Passive Optical Network (PON) having an Optical Line Terminal (OLT) and multiple Optical Network Terminals (ONTs) downstream of the OLT. The PON network includes passive optical communications paths configured to communicate in a bidirectional manner. The embodiment also includes an aggregator downstream of the multiple ONTs that provides selective access to the communications traffic received by the multiple ONTs, and includes a data collection node coupled to the aggregator that collects information representative of performance of the communications traffic to test traffic communications via the passive optical communications paths in a downstream direction. The data collection node reports the information to a network management node via the OLT to test traffic communications via a communications path to the network management node in an upstream direction.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a network diagram illustrating an example Passive Optical Network (PON).

FIG. 2 is a network diagram illustrating a network configuration for manually testing traffic performance in a PON network.

FIG. 3 is a network diagram illustrating a network configuration for testing traffic performance in a PON network using multiple set-top boxes.

FIG. 4 is a network diagram illustrating a network configuration for testing traffic performance in a PON network using a single data collection node.

FIG. 5 is a network diagram illustrating a network configuration for testing traffic performance in a PON network using a single data collection node, a content server, and a test management node.

FIGS. 6A-6C are network diagrams illustrating a flow of communications traffic and performance information in a network configuration for testing traffic performance in a PON network using a single data collection node.

FIG. 7 is a block diagram illustrating a system for testing traffic performance in a PON network using an aggregator and a single data collection node.

FIG. 8 is a flow diagram illustrating testing traffic performance over a PON network using an aggregator and a single data collection node.

FIG. 9 is a flow diagram illustrating testing traffic performance in a PON network using a single data collection node.

FIG. 10 is a flow diagram illustrating sending and receiving information in a PON network for testing communications traffic performance.

FIG. 11 is a flow diagram illustrating testing traffic performance in a PON network according to a selectable timing configuration.

FIG. 12 is a flow diagram illustrating further using communications traffic performance information collected by testing traffic performance in a PON network.

### DETAILED DESCRIPTION OF THE INVENTION

A description of example embodiments of the invention follows.

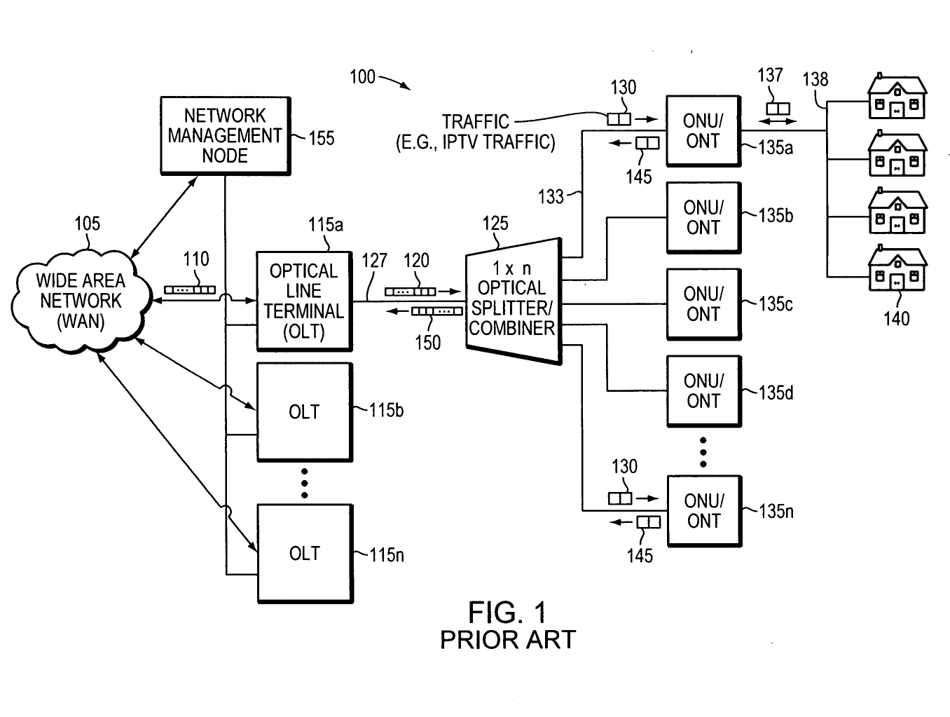

FIG. 1 is a network diagram of a Passive Optical Network (PON) 100. The network includes at least one Optical Line Terminal (OLT) 115a-115n, a network management node 155 (e.g., Element Management System (EMS)), an Optical Splitter/Combiner (OSC) 125, and at least one Optical Network Unit (ONU) or Optical Network Terminal (ONT), 135a-135n (hereinafter both referred to as an ONT), where an ONU generally supports multiple premises and an ONT generally supports a single premises. Data communications 110 may be transmitted between the OLTs 115a-115n and a wide area network (WAN) 105.

Communication of data transmitted between a given OLT 115a and its associated ONTs 135a-135n may be performed using standard communication protocols known in the art, for example, point-to-multipoint (e.g., broadcast with identifiers of intended recipients) for transmitting downstream data from the OLT 115a to the ONTs 135a-135n and point-to-point for transmitting upstream data from an individual ONT 135a-135n back to the OLT 115a (e.g., time division multiple access (TDMA)).

The PON 100 may be deployed for fiber-to-the-premises (FTTP), fiber-to-the-curb (FTTC), fiber-to-the-node (FTTN), and other fiber-to-the-x (FTTX) applications. The optical fiber 127, 133 in the PON 100 may operate at bandwidths such as 155 Mb/sec, 622 Mb/sec, 1.25 Gb/sec, and 2.5 Gb/sec, or any other desired bandwidth implementation. The PON 100 may incorporate asynchronous transfer mode (ATM) communications, broadband services such as Ethernet access and video distribution, Ethernet point-to-multipoint topologies, native communications of data and time division multiplex (TDM) formats, and other communications suitable for a PON. Customer premises equipment (e.g., inside homes 140) that can receive and provide communications in the PON 100 may include standard telephones (e.g., Public Switched Telephone Network (PSTN) and cellular), Internet Protocol telephones, Ethernet units, video devices, computer terminals, digital subscriber line connections, cable modems, wireless access, as well as any other conventional customer premises equipment.

The OLT 115a generates or passes through downstream communications 120 to an OSC 125. After passing through the OSC 125, the downstream communications 130 are broadcast to the ONTs 135a-135n, where each ONT 135a-135n reads data 130 intended for that particular ONT 135a-135n using, for example, identification information embedded within the communications signal. Data communications 137 may be further transmitted to and from, for example, a user's home 140 in the form of voice, data, video, and/or telemetry over copper, fiber, or other suitable connection 138 as known to those skilled in the art. The ONTs 135a-135n transmit upstream communication signals 145 back to the OSC 125 via fiber connections 133. The OSC 125, in turn, combines the ONTs 135a-135n upstream communications signals 145 and transmits the combined signals 150 back to the OLT 115a using, for example, a TDM protocol. The OLT 115a may further transmit the communication signals 110 to the WAN 105.

Communications between the OLT 115a and the ONTs 135a-135n occur using a downstream wavelength and an upstream wavelength. The downstream communications from the OLT 115a to the ONTs 135a-135n may be provided at, for example, 622 megabytes per second, which may be shared across all ONTs. The upstream communications from the ONTs 135a-135n to the OLT 115a may be provided at, for example, 155 megabytes per second, which may shared among all ONTs 135a-135n connected to the OSC 125.

Internet Protocol Television (IPTV) traffic may be delivered to viewers over the PON network. To ensure reliable performance, the PON network is typically tested before deploying the network equipment in the field.

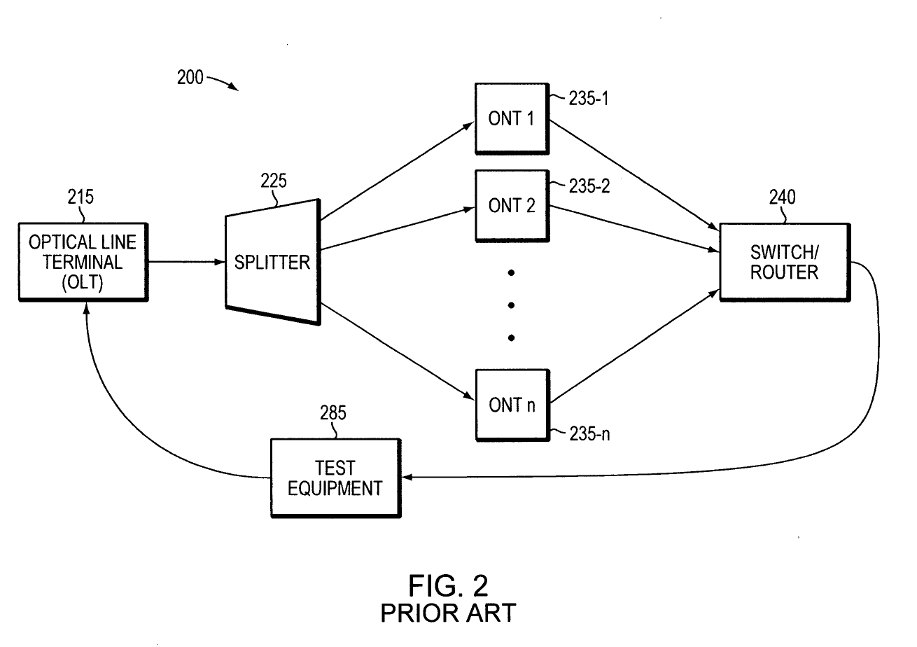

FIG. 2 is a network diagram illustrating a network configuration for manually testing traffic performance in a PON network 200 having a number of ONTs 235, which is one method for pre-deployment testing. The method involves the use of a single piece of testing equipment 285 to analyze traffic on the PON network 200. The equipment 225 is manually cycled through each ONT device 235, and performance data is gathered for each ONT 235. The data is later manually correlated together into a summary report. Given a fully loaded PON configuration (e.g., a PON network supporting up to thirty-two ONT units), it is extremely time-consuming and inefficient to manually walk through each ONT device 235 and correlate the gathered data. Additionally, the method does not test communications traffic performance in an upstream direction.

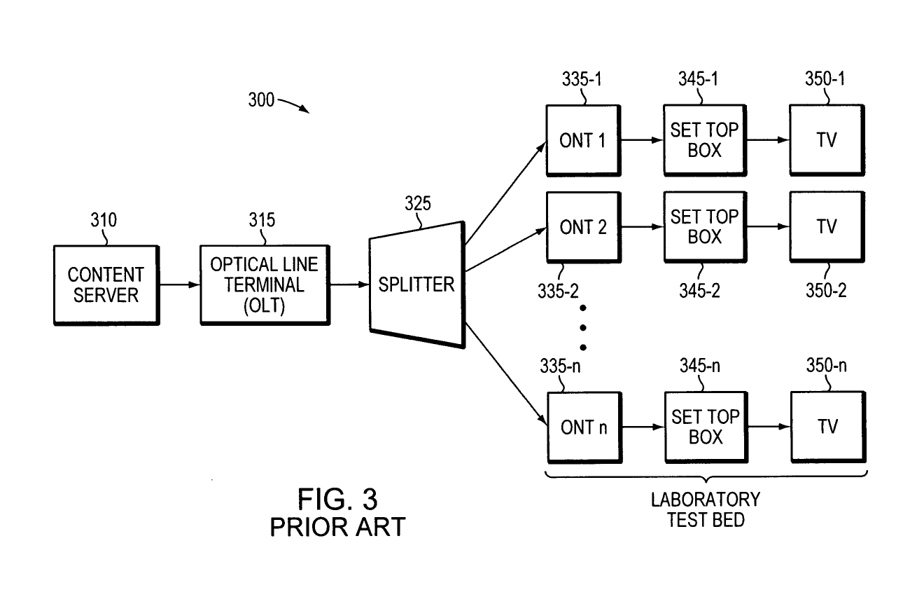

FIG. 3 is a network diagram illustrating a network configuration for testing traffic performance in a PON network 300 having a number of ONTs 335 using multiple set-top boxes 345, which is another approach for measuring IPTV traffic performance. The approach involves building an extensive test bed of expensive equipment that simulates communications traffic (e.g., IPTV traffic) and generates individual performance reports. The individual performance reports are then correlated by software and consolidated into a single report for the entire PON network 300. Given the high capital outlay required to source the equipment and the labor-intensive configuration required to control the tests, this approach is not cost-effective. As with the method above, this approach also does not test communications traffic performance in an upstream direction.

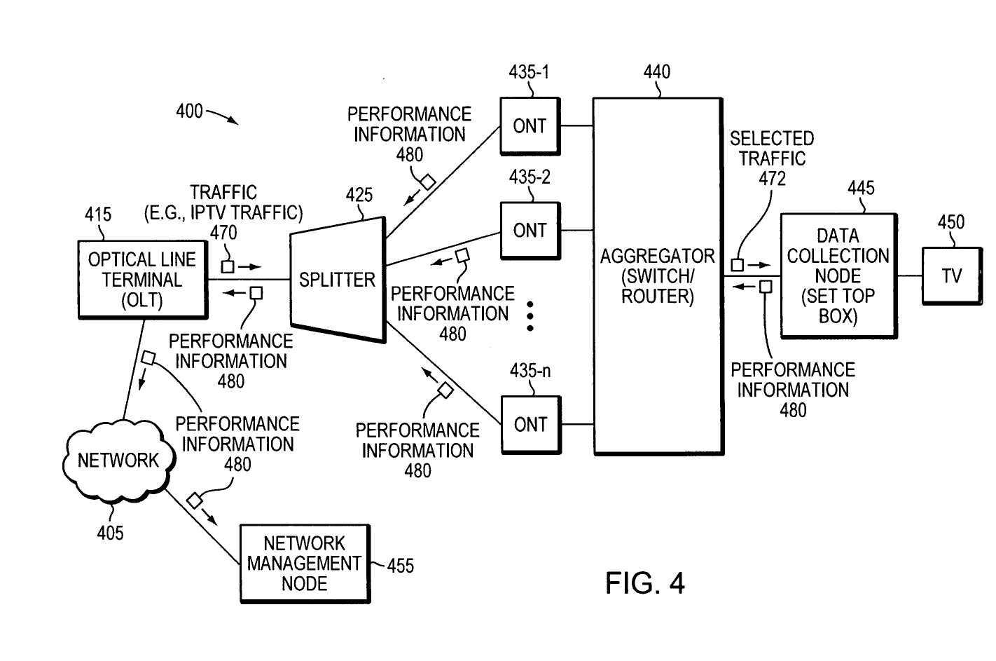

FIG. 4 is a network diagram illustrating a network configuration for testing traffic performance in a PON network 400 using a single data collection node 445, such as a set-top box, according to an example embodiment of the present invention. The embodiments of the present invention overcome the limitations of the approaches described above. One such embodiment is a method for measuring and reporting communications traffic performance in a Passive Optical Network (PON) 400 having an Optical Line Terminal (OLT) 415 and multiple Optical Network Terminals (ONTs) 435 downstream of the OLT 415. According to the method, the embodiment transmits communications traffic 470 in a downstream direction via passive optical communications paths in the PON network 400. At a point downstream of the multiple ONTs 435, the embodiment aggregates the communications traffic 470 received by the multiple ONTs 435, selectively accesses the aggregated communications traffic, and collects information representative of performance of the selected communications traffic 472 to test communications traffic via the passive optical communications paths in a downstream direction. Once the performance information 480 is collected, the embodiment reports the information 480 in an upstream direction to a network management node 455, such as an Element Management System (EMS) or a Network Management System (NMS), via the OLT 415 to test communications traffic via a communications path to the network management node 455 in an upstream direction.

Transmitting the communications traffic 470 in the downstream direction may include transmitting communications traffic that is aggregated and selectively accessed according to a selectable timing configuration, and may include transmitting selectable characteristics to the OLT 415 to be distributed to the ONTs 435 along with the communications traffic 470. Collecting information representative of performance of the selected communications traffic 472 may include displaying the content of the selected communications traffic 472 on customer premises equipment 450, such as a television or other display unit. Reporting the information 480 upstream to the network management node 455 may include correlating the information 480 with test scenarios effected in the downstream traffic 470, such as format, delay, content, frame type, and frame size test scenarios. The network management node 455 may store the performance information 480 and may use the stored performance information to test other networks or may sell the stored performance information as part of a deployment service (e.g., simulation results).

Advantages provided by the embodiments of the present invention include 1) simplifying the testing process by consolidating all reports in one place (such as the network management node 455), 2) enabling more flexible testing, as multiple traffic characteristics can be more easily triggered and measured, and 3) creating value from the testing process by organizing the collected information into traffic models and using the information in conjunction with simulation tools during customer deployment, which may then serve to generate revenue through various professional services.

In one example embodiment for testing communications traffic, a PON network 400, which includes an OLT 415, an Optical Splitter/Combiner (OSC) 425, a number of ONTs 435 (for example, thirty two ONTs), an aggregator 440, such as a layer-2 switch, layer-3 router, or wireless device (hereinafter referred to as a switch), and a data collection node 445, such as a set-top box (STB), is provided. New equipment may be provided, or an existing ONT farm test bed in a laboratory may be used. According to the example embodiment, the data collection node (e.g., STB) 445 is connected to an aggregate port of the switch 440 and may be connected to a high definition television (HDTV) set 450 as well. Ethernet ports (not shown) of the ONTs 435 (for example, ports 1 through 32) are connected to respective individual ports (not shown) of the switch 440.

In this example embodiment, the STB 445 scans each channel across all ONTs 435 using a Virtual LAN (VLAN) filter. To do so, VLAN group identifiers that map the ONT Ethernet ports are configured, and the VLAN port identifiers are associated with respective individual ports of the switch 440, which are connected to the respective ONTs 435. For example, switch ports 1 through 32 may be connected to Ethernet ports 1 through 32 of the respective ONTs 435. The VLAN port identifiers are also associated with the aggregate port of the switch 440.

Multiple multicast Internet Group Management Protocol (IGMP) addresses are defined and associated with the unique VLAN identifiers, for example, one address for each IPTV stream. The IGMP addresses may be defined by running a script on the STB 445. Each multicast address and VLAN identifier represents a unique IPTV channel over a particular ONT 435.

To initiate the collection of performance data, the STB 445 sends “join requests” upstream for each ONT 435. In response, multicast group traffic 470 is sent downstream to the ONTs 435. Multiple IPTV streams (channel programs) are sent in multicast format via the OLT 415, such as thirty-two IPTV streams (one for each ONT 435). IGMP snooping mechanisms in the ONTs 435 determine which host should receive what multicast stream based on a learned IGMP “join” packet. According to the example embodiment, the VLAN identifier in the switch indicates from which ONT 435 the STB 445 will receive the IPTV stream, and the multicast address determines which channel is to be viewed.

The STB 445 cycles through each channel on a periodic basis, for example, every ten seconds. That is, in a PON network having thirty two ONTs, the STB 445 may soak (i.e., measure performance data) on channel 1 over the first ONT 435-1 for ten seconds before switching to channel 2 over the second ONT 435-2. The STB 445 may continue to switch from ONT to ONT until performance for all thirty two channels over the thirty two ONTs 435 have been measured. Such periodic cycling may be controlled though the use of a script and may continuously loop though the ONTs 435.

While scanning through each channel from each ONT 435, the STB 445 records data relating to channel performance. Once the performance data 480 is collected in this example embodiment, the STB 445 reports the traffic performance data 480 for analysis, for example, by sending the performance results 480 via HTTP and threshold crossing alarms via Simple Network Management Protocol (SNMP) of each ONT 435 to a network management node 455, such as an Element Management System (EMS) or Network Management System (NMS). The management data transport between data collection node 445 and the network management node 455 may be through in-band private VLAN that runs through the OLT's 415 ONT Management Control Interface (OMCI) channel.

After processing and analyzing the data, the network management node 455 generates IPTV performance reports for each channel in an example embodiment. The network management node 455 may store, either internally or externally, the performance information based on various traffic characteristics. This valuable information can be organized in such way that is commercialized and used by customers for network traffic modeling and simulation.

The above example embodiment may therefore, by scanning through all thirty-two ONT devices using a single data collection node (e.g., a single STB), provide a realistic and cost effective test environment that reflects IPTV subscriber growth expectation (for example, on thirty-two homes).

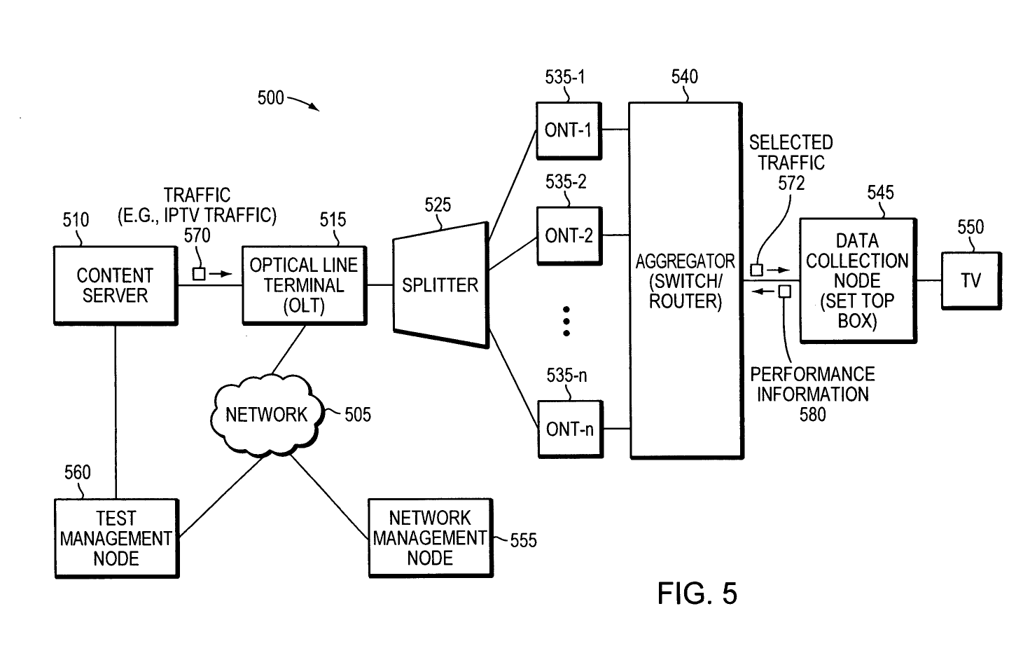

FIG. 5 is a network diagram illustrating a network configuration for testing traffic performance in a PON network 500 using a single data collection node 545, such as a set-top box (STB), a content server 510, and a test management node 560, according to another example embodiment of the present invention. In such an embodiment, the content server 510 may receive a “join request” message from the data collection node 545, and may respond by sending multicast IPTV streams 570 to the ONTs 535 via an OLT 515 uplink. Additionally, the example embodiment includes a test management node 560 that, according to various test scenarios, causes the content server 510 to transmit traffic 570 with selectable characteristics to the OLT 515, which is then distributed to the ONTs 535. The test management node 560 may run scripts to control the characteristics of the content server's 510 output for a given test scenario. Such characteristics may include differences in traffic format, delay, content, frame type, and frame size. According to the example embodiment, upon collection of the performance information 580, the network management node 555 correlates the collected performance information with the test scenarios that were effected in the downstream communications traffic.

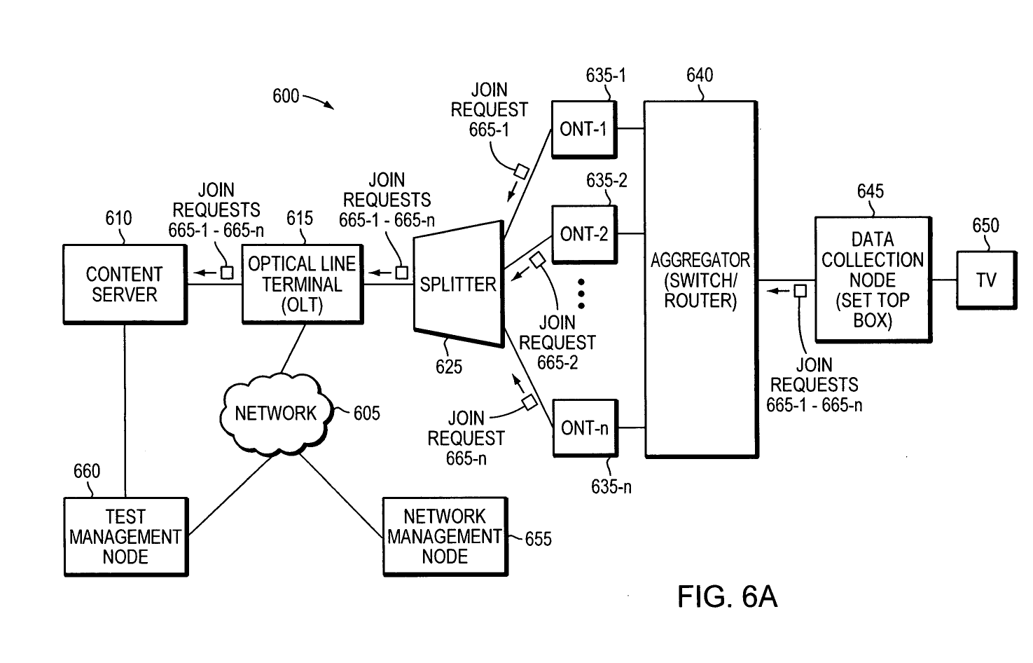

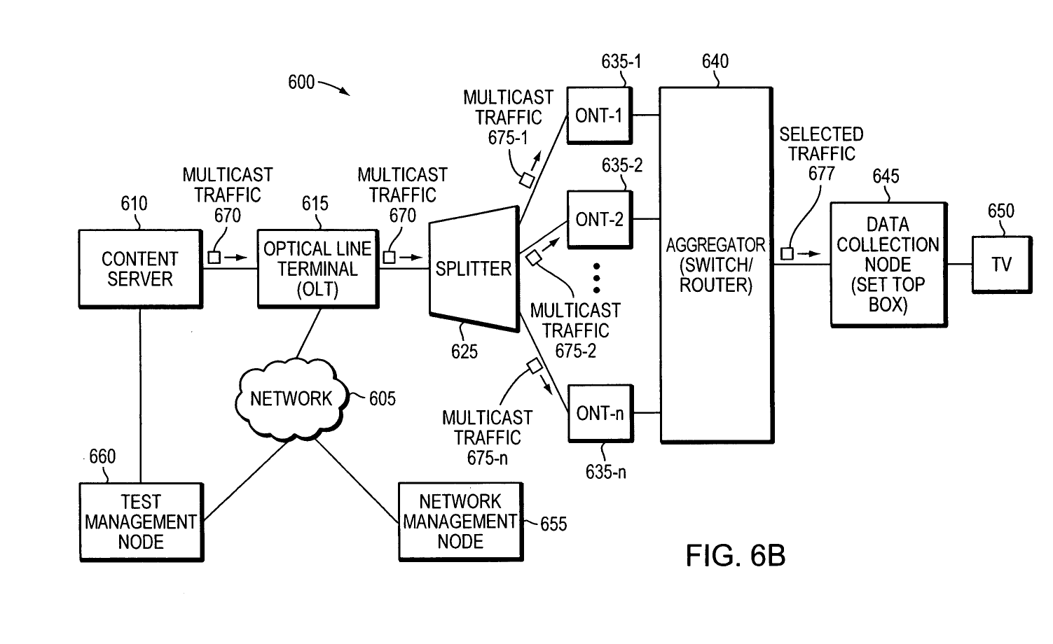

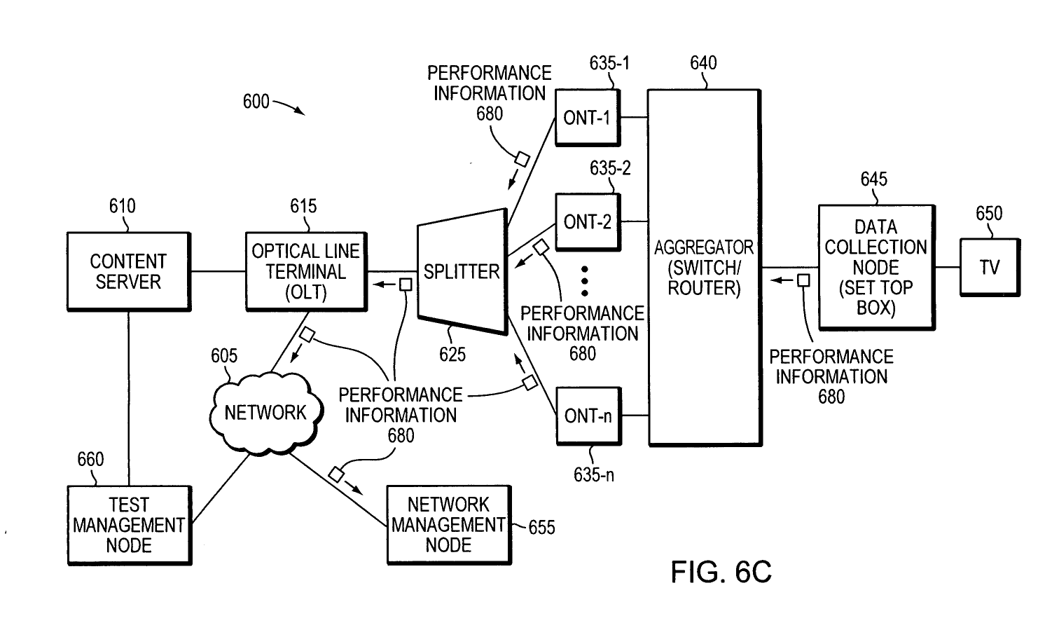

FIG. 6A-6C are network diagrams illustrating a flow of communications traffic in a network configuration for testing traffic performance in a PON network 600 using a single data collection node 645, such as a set-top box (STB), according to another example embodiment of the present invention.

FIG. 6A illustrates the STB (i.e., the data collection node) 645 sending channel “join requests” 665 to a content server via each ONT 635. The switch 640 forwards each channel “join request” 665 through the respective ONT 635. Each ONT 635 forwards the channel “join request” 665 to the content server 610 via the OSC 625 and the OLT 615.

FIG. 6B illustrates the content server 610 sending multicast communication traffic 670, 675 corresponding to the “join requests” 665 to the ONTs 635. At this point, the test management node 660 may launch configuration scripts to control the content server's 610 output characteristics. Upon receiving the multicast traffic 670, 675 at the ONTs 635, the STB 645 scans each channel associated with each ONT 635 using a VLAN filter, as described above, and records information relating to each channel's performance.

FIG. 6C illustrates the STB (i.e., the data collection node) 645 sending the collected performance information 680 to a network management node 655, where the information 680 is processed and analyzed. The network management node 655 generates further information regarding the performance of each channel and stores the generated information for future use. The information may be stored internally or externally and may be organized based on various traffic characteristics.

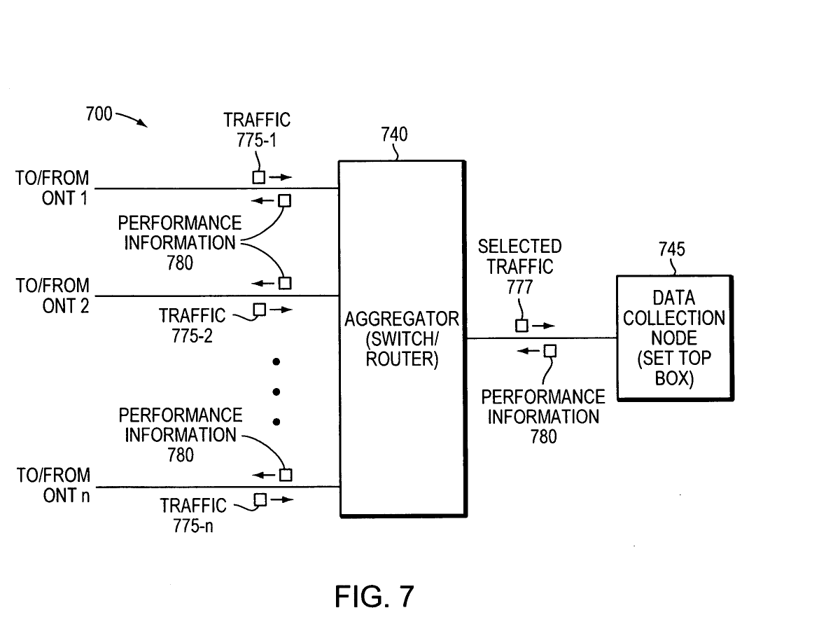

FIG. 7 is a block diagram illustrating a system 700 for testing traffic performance in a PON network using an aggregator 740 and a single data collection node 745, according to an example embodiment of the present invention. According to this example embodiment, an aggregator 740, such as a layer-2 switch, layer-3 router, or wireless device, aggregates communication traffic received by multiple ONTs. A data collection node 745, such as a set-top box (STB), is in communication with the aggregator 740 and selectively accesses the aggregated communications traffic. The data collection node 745 then measures the performance of each selected communications traffic 777, and records data 780 representative of the measured performance. Once the performance data 780 is collected, the data collection node 745 reports the performance data 780 to a network management node (not shown).

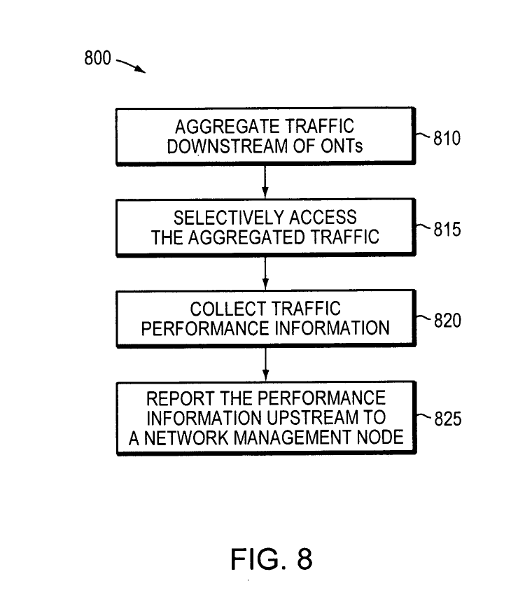

FIG. 8 is a flow diagram 800 illustrating testing traffic performance in a PON network using an aggregator and a single data collection node, according to an example embodiment of the present invention. According to the example embodiment, communications traffic that is received at multiple ONTs in a passive optical network is aggregated at a point downstream of the multiple ONTs (810). The traffic is then selectively accessed (815) and information representative of performance of the selected communications traffic is collected (820). The collected information is then reported by transmitting the information in an upstream direction to a network management node (825).

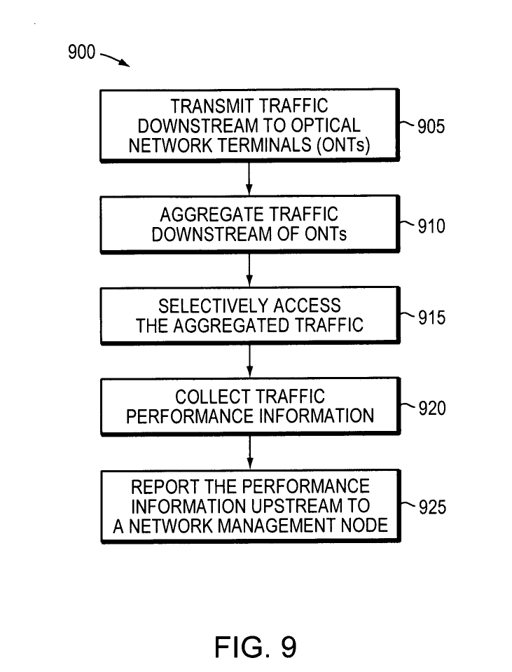

FIG. 9 is a flow diagram 900 illustrating testing of traffic performance in a PON network using a single data collection node, according to an example embodiment of the present invention. According to this example embodiment, communications traffic is first transmitted in a downstream direction to multiple ONTs (905). Then, similar to the example embodiment of FIG. 8, the communications traffic received by the multiple ONTs is aggregated at a point downstream of the multiple ONTs (910). The aggregated traffic is then selectively accessed (915) and information representative of performance of the selected communications traffic is collected (920). The collected information is then reported by transmitting the information in an upstream direction to a network management node (925).

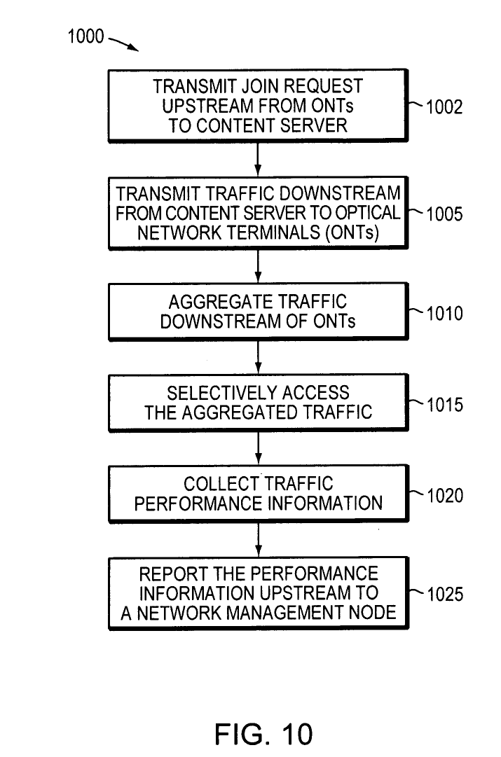

FIG. 10 is a flow diagram 1000 illustrating sending and receiving information in a PON network for testing communications traffic performance, according to an example embodiment of the present invention. According to the example embodiment, communications traffic to be transmitted in a downstream direction to multiple ONTs is initiated by sending “join requests” in an upstream direction via the ONTs to a content server (1002). Upon receiving the “join requests,” the content server transmits the communications traffic to the multiple ONTs (1005). As described above, the communications traffic received by the multiple ONTs is aggregated at a point downstream of the multiple ONTs (1010), selectively accessed (1015), and information representative of the selected communications traffic's performance is collected (1020), which is then transmitted in an upstream direction to a network management node (1025).

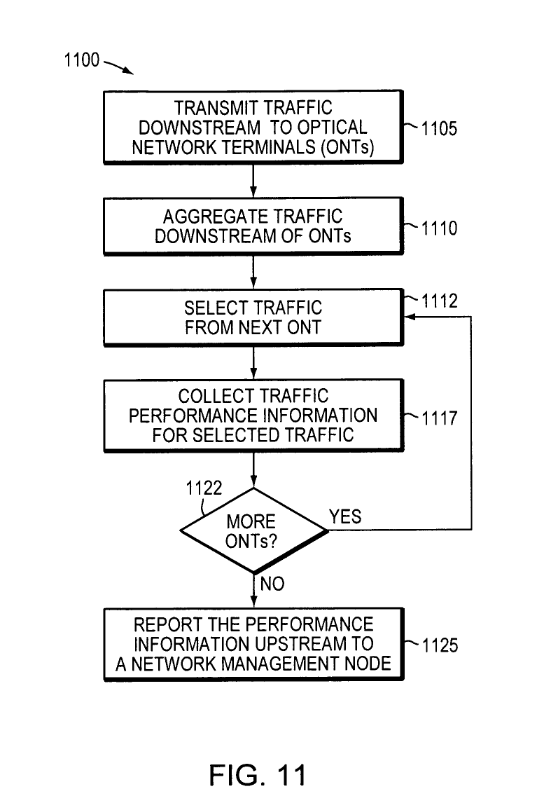

FIG. 11 is a flow diagram 1100 illustrating testing of traffic in a PON network according to a selectable timing configuration. According to the example embodiment, once communications traffic is transmitted in a downstream direction to multiple ONTs (1105) and aggregated at a point downstream of the multiple ONTs (1110), the aggregated communications traffic is selectively accessed according to a selectable timing configuration. According to the timing configuration, the example embodiment selects communications traffic from a given ONT (1112), and information representative of performance of a selected communications traffic from the given ONT is collected (1117). When the information has been collected for a duration specified by the timing configuration, performance information for another selected communications traffic from another ONT is collected, until performance information has been collected for the communications traffic from all of the ONTs (1112, 1117, 1122). The collected information is then reported by transmitting the information in an upstream direction to a network management node (1125).

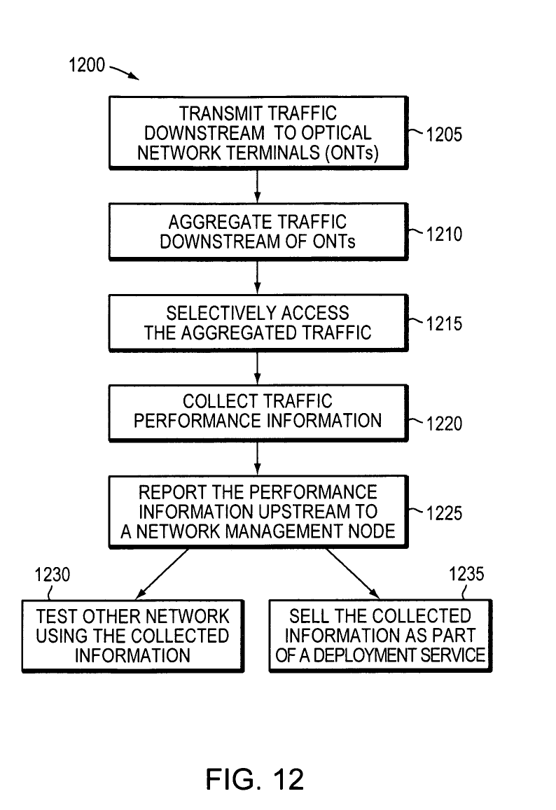

FIG. 12 is a flow diagram 1200 illustrating further using communications traffic performance information collected by testing traffic performance in a PON network, according to an example embodiment of the present invention. According to the example embodiment, once the collected channel performance information is reported to a network management node (1205, 1210, 1215, 1220, 1225), the information may be stored for future use. One example future use is to use the collected information to test traffic performance in other PON networks (1230). Another example is to sell the collected information as part of a professional service for deployed systems (1235).

While this invention has been particularly shown and described with references to example embodiments thereof, it will be understood by those skilled in the art that various changes in form and details may be made therein without departing from the scope of the invention encompassed by the appended claims. For example, the aggregator may take the form of a layer-2 switch, layer-3 router, or wireless communications device. In embodiments using a wireless device, communications may be transmitted and received using Radio Frequency (RF) communications (e.g., WiFi 802.11 communications). In such embodiments, the wireless device may aggregate the communications traffic at, for example, the data collection node (e.g., STB). Additionally, while the above example embodiments include to a PON network carrying IPTV traffic, embodiments for testing performance of traffic other than IPTV traffic may be implemented.

It should be understood that the flow diagrams of FIGS. 8-12 are examples that can include more or fewer components, be partitioned into subunits, or be implemented in different combinations. Moreover, the flow diagrams may be implemented in hardware, firmware, or software. If implemented in software, the software may be written in any software language suitable for use in networks as illustrated in FIGS. 4-7. The software may be embodied on any form of computer readable medium, such as RAM, ROM, or magnetic or optical disk, and loaded and executed by generic or custom processor(s).

What is claimed is:

1. A network for measuring and reporting traffic performance, the network comprising:
a passive optical network having an optical line terminal (OLT) and multiple optical network terminals (ONTs) downstream of the OLT, the passive optical network configured to communicate in a bidirectional manner via passive optical communications paths;
an aggregator downstream of the multiple ONTs to provide selective access to communications traffic received by the multiple ONTs; and
a data collection node in communication with the aggregator to collect information representative of performance of the communications traffic and to report the performance information to a network management node via the OLT to test traffic communications via the passive optical communications paths in a downstream direction and via a communications path to the network management node in an upstream direction.

2. A network as in claim 1 further comprising:
a content server; and
a test management node that causes the content server to transmit traffic with selectable characteristics to the OLT to distribute the traffic to the ONTs.

3. A network as in claim 1 wherein the aggregator is a layer-two switch, a layer-three router, or a wireless device.

4. A network as in claim 1 wherein the data collection node includes customer premises equipment.

5. A network as in claim 4 wherein the customer premises equipment includes a display unit to display content of the communications traffic.

6. A network as in claim 1 wherein the aggregator provides selective access to the communications traffic received by the multiple ONTs according to a selectable timing configuration.

7. A network as in claim 1 wherein the network management node correlates the collected information with test scenarios effected in the downstream traffic.

8. A network as in claim 7 wherein the test scenarios include format, delay, content, frame type, and frame size test scenarios.

9. A network as in claim 1 wherein the information includes performance data and wherein the network management node stores the performance data.

10. A network as in claim 9 further comprising a test management node to use the information in future testing of other networks.

11. A network as in claim 9 wherein the information is sold as simulation results as part of a deployment service.

12. A method for measuring and reporting traffic performance in a network, the method comprising:
transmitting communications traffic in a downstream direction via passive optical communications paths in a passive optical network, the passive optical network having an optical line terminal (OLT) and multiple optical network terminals (ONTs) downstream of the OLT;
aggregating the communications traffic received by the multiple ONTs at a point downstream of the multiple ONTs;
selectively accessing the aggregated communications traffic;
collecting information representative of performance of the selected communications traffic; and
reporting the information in an upstream direction to a network management node via the OLT to test communications traffic via the passive optical communications paths in a downstream direction and via a communications path to the network management node in an upstream direction.

13. A method as in claim 12 wherein transmitting communications traffic in a downstream direction includes transmitting communications traffic with selectable characteristics to the OLT to distribute the traffic to the ONTs.

14. A method as in claim 12 wherein collecting information representative of performance of the selected communications traffic includes displaying the content of the selected communications traffic on customer premises equipment.

15. A method as in claim 12 wherein transmitting communications traffic in a downstream direction includes transmitting multicast traffic and wherein selectively accessing the aggregated communications traffic includes selectively accessing the aggregated communications traffic according to a selectable timing configuration.

16. A method as in claim 12 wherein reporting the information upstream to a network management node includes correlating the information with test scenarios effected in the downstream traffic.

17. A method as in claim 16 wherein the test scenarios include format, delay, content, frame type, and frame size test scenarios.

18. A method as in claim 12 wherein reporting the information upstream to a network management node includes storing the performance data provided in the information.

19. A method as in claim 18 further comprising using the stored information to test other networks.

20. A method as in claim 18 further comprising selling the stored information as simulation results as part of a deployment service.

21. A computer readable medium having computer readable program codes embodied therein for measuring and reporting traffic performance in a network, the computer readable medium program codes including instructions that, when executed by a processor, cause the processor to:
transmit communications traffic in a downstream direction via passive optical communications paths in a passive optical network, the passive optical network having an optical line terminal (OLT) and multiple optical network terminals (ONTs) downstream of the OLT;
aggregate the communications traffic received by the multiple ONTs at a point downstream of the multiple ONTs;
selectively access the aggregated communications traffic;
collect information representative of performance of the selected communications traffic; and
report the information in an upstream direction to a network management node via the OLT to test communications traffic via the passive optical communications paths in a downstream direction and via a communications path to the network management node in an upstream direction.

22. A system for measuring and reporting traffic performance in a passive optical network, the system comprising:
an aggregator to provide selective access to communications traffic received by multiple optical network terminals in the passive optical network, the aggregator being downstream of the multiple optical network terminals; and
a data collection node in communication with the aggregator to collect information representative of performance of the communications traffic and to report the performance information upstream to a network management node to test the traffic communications in both downstream and upstream directions.

23. A method for measuring and reporting traffic performance in a passive optical network, the method comprising:
aggregating communications traffic received by multiple optical network terminals in the passive optical network at a point downstream of the multiple optical network terminals;
selectively accessing the aggregated communications traffic;
collecting information representative of performance of the selected communications traffic; and
reporting the information in an upstream direction to a network management node to test the communications traffic in both downstream and upstream directions.
